(19) United States
(12) Patent Application Publication
(10) Pub. No.: US 2026/0017233 A1
(43) Pub. Date: Jan. 15, 2026

(54) AUTOMATED FILE ADJUSTMENT METHOD AND AUTOMATED FILE ADJUSTMENT SYSTEM

(71) Applicant: IsCoolLab Co., Ltd., Taipei City (TW)

(72) Inventor: YAN-MEI JIANG, Taipei City (TW)

(21) Appl. No.: 18/951,993

(22) Filed: Nov. 19, 2024

(30) Foreign Application Priority Data
Jul. 15, 2024 (TW) 113126357

(51) Int. Cl. G06F 16/16; G06F 16/14

(52) U.S. Cl. CPC G06F 16/16; G06F 16/148

(57) ABSTRACT

An automated file adjustment method and an automated file adjustment system are provided. The automated file adjustment method is applicable to an electronic device. The automated file adjustment method includes: selecting, from a plurality of automated operation processes in a database of the electronic device, at least one of the automated operation processes according to a content of a specified request, in which the at least one of the automated operation processes corresponds to the content of the specified request; and adjusting, according to the at least one of the automated operation processes that corresponds to the content of the specified request, a content of a first file, so as to obtain a content of the adjusted first file.

### CROSS-REFERENCE TO RELATED PATENT APPLICATION

This application claims the benefit of priority to Taiwan Patent Application No. 113126357, filed on Jul. 15, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an automated file adjustment method and an automated file adjustment system, and more particularly to an automated file adjustment method and an automated file adjustment system that are low in costs.

### BACKGROUND OF THE DISCLOSURE

A user is required to modify a file according to a content of a specified request, and there is difficulty in adopting other ways of modification. Apart from costing a substantial amount of time and human resources, file modification involves complicated steps and laborious confirmation. Therefore, how to provide an automated file adjustment method and an automated file adjustment system that are low in costs has become one of the important issues to be solved in the relevant industry.

### SUMMARY OF THE DISCLOSURE

In response to the above-referenced technical inadequacies, the present disclosure provides an automated file adjustment method and an automated file adjustment system.

In order to solve the above-mentioned problems, one of the technical aspects adopted by the present disclosure is to provide an automated file adjustment method. The automated file adjustment method is applicable to an electronic device, and includes: selecting, from a plurality of automated operation processes in a database of the electronic device, at least one of the automated operation processes according to a content of a specified request, in which the at least one of the automated operation processes corresponds to the content of the specified request; and adjusting, according to the at least one of the automated operation processes that corresponds to the content of the specified request, a content of a first file, so as to obtain a content of the adjusted first file.

In order to solve the above-mentioned problems, another one of the technical aspects adopted by the present disclosure is to provide an automated file adjustment system. The automated file adjustment system includes an electronic device, and the electronic device includes a process automation application. From a plurality of automated operation processes in a database of the electronic device, the process automation application selects at least one of the automated operation processes according to a content of a specified request. The at least one of the automated operation processes corresponds to the content of the specified request. According to the at least one of the automated operation processes that corresponds to the content of the specified request, the process automation application adjusts a content of a first file to obtain a content of the adjusted first file. The process automation application compares the content of the specified request with the content of the adjusted first file to obtain a comparison result. According to the comparison result, the process automation application determines whether or not to output the content of the adjusted first file.

Therefore, the automated file adjustment method and the automated file adjustment system provided by the present disclosure can assist a user in quickly and efficiently completing a complicated file adjustment task that takes up a great amount of time and efforts, so as to effectively reduce labor and time costs. Furthermore, implementation costs and development time for process automation can be significantly reduced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of an automated file adjustment method according to a first embodiment of the present disclosure;

FIG. 2 is a schematic diagram showing implementation of the automated file adjustment method via an electronic device according to the first embodiment of the present disclosure;

FIG. 3 is another schematic diagram showing implementation of the automated file adjustment method via the electronic device according to the first embodiment of the present disclosure;

FIG. 4A to FIG. 4C are each a schematic view showing a step of the automated file adjustment method according to the first embodiment of the present disclosure; and

FIG. 5 is a schematic diagram of an automated file adjustment system according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

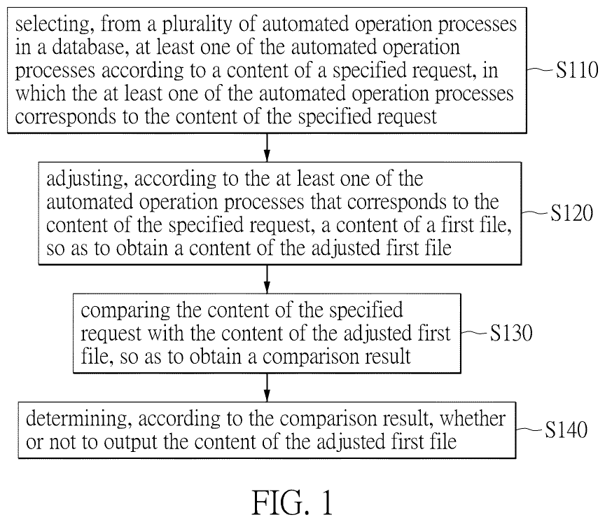

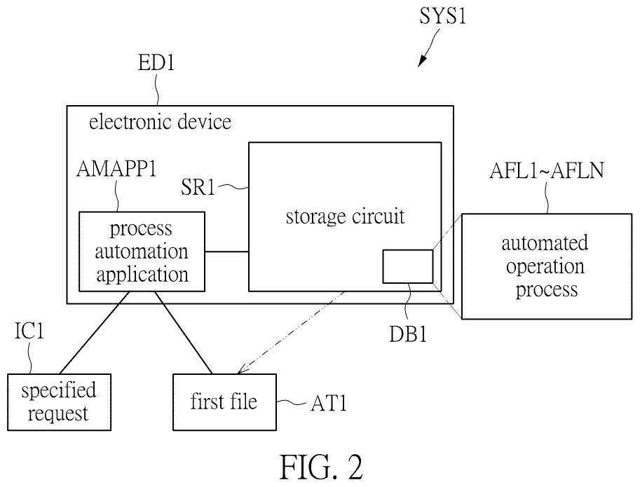

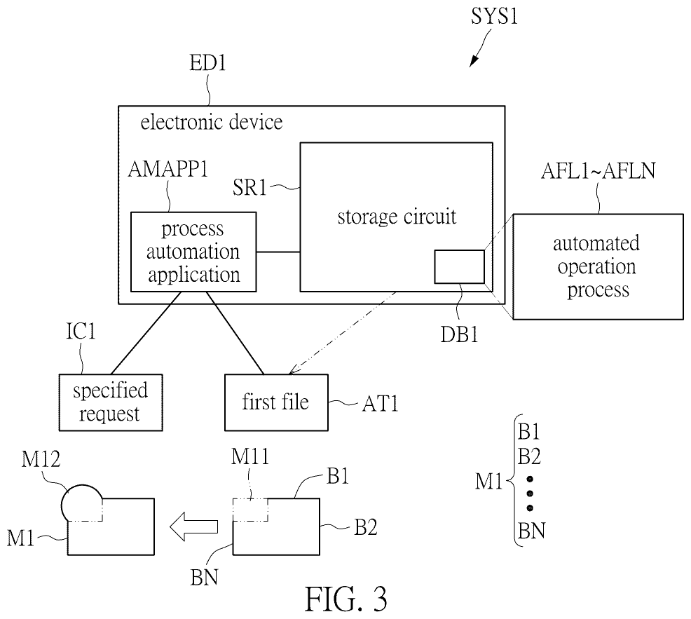

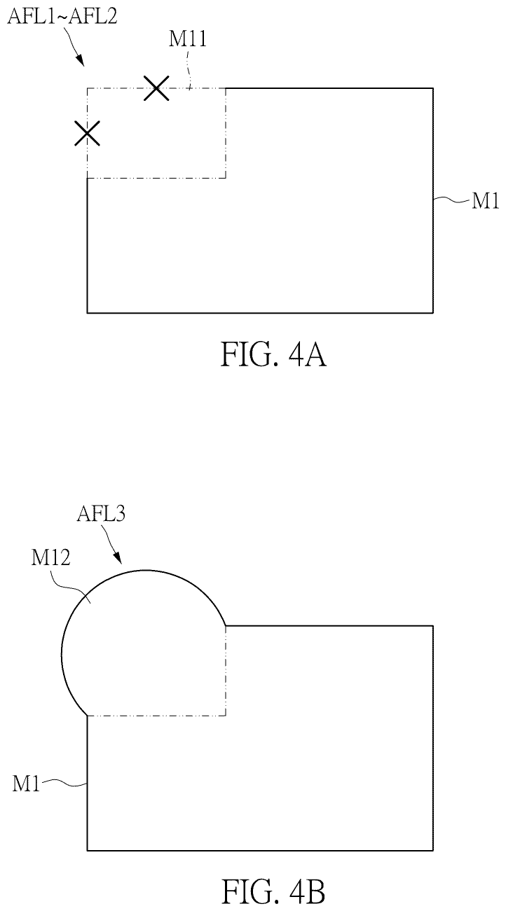

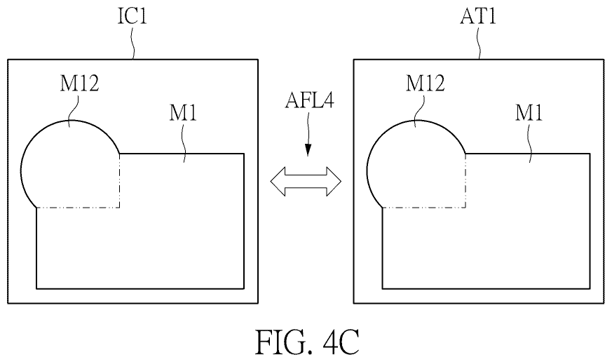

Referring to FIG. 1, FIG. 2, FIG. 3, FIG. 4A, FIG. 4B, and FIG. 4C, FIG. 1 is a flowchart of an automated file adjustment method according to a first embodiment of the present disclosure, FIG. 2 is a schematic diagram showing implementation of the automated file adjustment method via an electronic device according to the first embodiment of the present disclosure, FIG. 3 is another schematic diagram showing implementation of the automated file adjustment method via the electronic device according to the first embodiment of the present disclosure, and FIG. 4A to FIG. 4C are each a schematic view showing a step of the automated file adjustment method according to the first embodiment of the present disclosure.

The present embodiment provides an automated file adjustment method. The automated file adjustment method provided in the present embodiment is applicable to an electronic device ED1. The following steps are included to adjust a content of a first file according to a content of a specified request.

Step S110: selecting, from a plurality of automated operation processes in a database, at least one of the automated operation processes according to the content of the specified request, in which the at least one of the automated operation processes corresponds to the content of the specified request.

Step S120: adjusting, according to the at least one of the automated operation processes that corresponds to the content of the specified request, the content of the first file, so as to obtain a content of the adjusted first file.

Step S130: comparing the content of the specified request with the content of the adjusted first file, so as to obtain a comparison result.

Step S140: determining, according to the comparison result, whether or not to output the content of the adjusted first file.

In step S110 and step S120, each automated operation process does not need to be performed by a user, but is processed by a process automation application AMAPP1 installed in the electronic device ED1.

Firstly, the process automation application AMAPP1 identifies a content of a specified request IC1, and opens a first file AT1. The process automation application AMAPP1 analyzes the content of the specified request IC1, and compares the content of the specified request IC1 with a content of the first file AT1, so as to determine which parts need to be adjusted. For example, FIG. 4A to FIG. 4C show a partial adjustment to a first partial graphic M11 of a graphic M1, and adjusting the first partial graphic M11 to a second partial graphic M12 is indicated in the content of the specified request IC1.

After confirming a task in the content of the specified request IC1, the process automation application AMAPP1 determines a plurality of automated operation processes AFL1 to AFLN that correspond to the task (which is to adjust the first partial graphic M11 to the second partial graphic M12) in the content of the specified request IC1. The automated operation processes AFL1 to AFLN are stored in a database DB1 of the electronic device ED1. The specified request IC1 can be a project file, a text instruction, or a graphical instruction.

In the present embodiment, the process automation application AMAPP1 firstly deletes the first partial graphic M11 in the first file AT1. By operating a peripheral device (e.g., a cursor of a mouse ME1), the process automation application AMAPP1 selects one or more lines of the first partial graphic MI1 (i.e., the first automated operation process AFL1), and then clicks a delete key in a project application that opens the first file AT1 (i.e., the second automated operation process AFL2). In this way, after deletion of the first partial graphic M11, the process automation application AMAPP1 begins to add a plurality of lines of the second partial graphic M12 (i.e., the third automated operation process AFL3).

In step S130 and step S140, the process automation application AMAPP1 proceeds to compare the adjusted first file AT1 (which includes the second partial graphic M12) with the content of the specified request IC1 (i.e., the fourth automated operation process AFL4). After comparison, if the second partial graphic M12 in the adjusted first file AT1 is the same as that in the content of the specified request IC1, the process automation application AMAPP1 provides an identical comparison result, and outputs and records the adjusted first file AT1. If the comparison result between the second partial graphic M12 in the adjusted first file AT1 and that in the content of the specified request IC1 shows minor differences, the process automation application AMAPP1 correspondingly re-selects the automated operation processes AFL1 to AFLN in the database DB1 for further modification.

The automated operation processes are determined according to a plurality of blocks B1 to BN that are established in the content of the first file AT1 by the user.

The blocks B1 to BN of the first file AT1 include a graphic, a text, a file format, an inspection process, or a line segment. Each of the automated operation processes AFL1 to AFLN at least corresponds to one of the blocks B1 to BN.

Without altering a software/hardware environment (which includes a software implementation or an underlying code connection) of the electronic device ED1, the automated operation processes AFL1 to AFLN are performed by a plurality of peripheral devices, multiple pieces of software, multiple pieces of firmware, or multiple pieces of hardware installed in the electronic device ED1.

In the present embodiment, corresponding ones of the automated operation processes can be pre-recorded in each of the blocks B1 to BN of the first file AT1. That is, the automated operation processes in each of the blocks B1 to BN can be edited and adjusted via the process automation application AMAPP1. The file format of the first file AT1 and that of the specified request IC1 are openable by one of the multiple pieces of software installed in the electronic device ED1. The specified request IC1 can also be image information photographed or recorded by a camera module (not shown in the figures) that is connected to the electronic device ED1.

### Second Embodiment

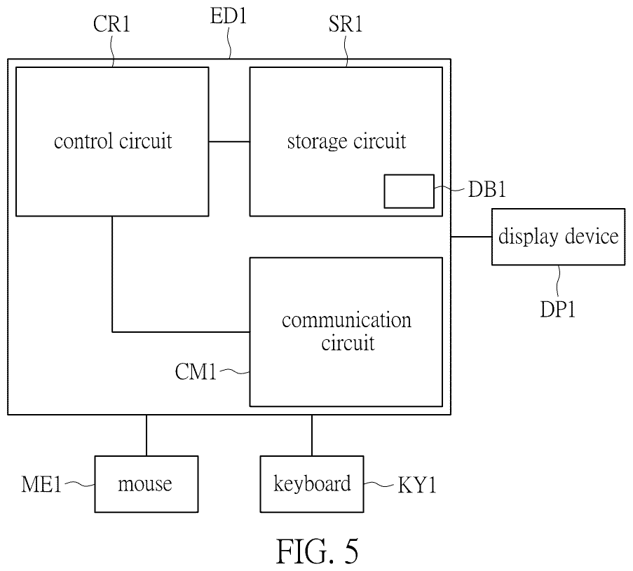

Reference is made to FIG. 5, which is a schematic diagram of an automated file adjustment system according to a second embodiment of the present disclosure.

The present embodiment provides an automated file adjustment system SYS1. The automated file adjustment system SYS1 at least includes the electronic device ED1. The electronic device ED1 includes a control circuit CR1, a storage circuit SRI, and a communication circuit CM1. The electronic device ED1 is connected to the mouse ME1 and a keyboard KYl. The electronic device ED1 is further connected to a display device DP1. The control circuit CR1 is connected to the storage circuit SRI and the communication circuit CM1.

The process automation application AMAPP1 is installed with the storage circuit SRI of the electronic device ED1. The storage circuit SRI of the electronic device ED1 further includes the database DB1, and the database DB1 includes the automated operation processes AFL1 to AFLN.

Each automated operation process does not need to be performed by the user, but is processed by the process automation application AMAPP1 installed in the electronic device ED1.

As shown in the embodiment of FIG. 3 to FIG. 4C, the process automation application AMAPP1 identifies the content of the specified request IC1, and opens the first file AT1. Then, the content of the specified request IC1 is analyzed and compared with the content of the first file AT1, so as to determine which parts need to be adjusted.

By using the technology of computer vision recognition, the process automation application AMAPP1 can analyze, capture, and store the automated operation processes AFL1 to AFLN in the database DB1 through operation processes in which the user operates the electronic device ED1, the user operates the mouse ME1, the user operates the keyboard KYl, the user operates a touch panel, the user uses communication software for communication, or the user uses various pieces of project software and commercial software. The process automation application AMAPP1 not only can analyze the content of the specified request IC1, but can also search and compare the automated operation processes AFL1 to AFLN, so as to appropriately and correspondingly obtain one or more of the automated operation processes AFL1 to AFLN.

Furthermore, the process automation application AMAPP1 compares the content of the specified request IC1 with the adjusted first file AT1 (which includes the second partial graphic M12), and only decides whether or not to output the adjusted first file AT1 after comparison. When the comparison result between the second partial graphic M12 in the adjusted first file AT1 and that in the content of the specified request IC1 shows minor differences, the process automation application AMAPP1 provides a non-identical comparison result. Afterwards, the process automation application AMAPP1 correspondingly re-selects the automated operation processes AFL1 to AFLN in the database DB1 for modification.

Without altering the software/hardware environment (which includes the software implementation or the underlying code connection) of the electronic device ED1, the automated operation processes AFL1 to AFLN are performed by the peripheral devices, the multiple pieces of software, the multiple pieces of firmware, or the multiple pieces of hardware installed in the electronic device ED1. For the automated operation processes AFL1 to AFLN, the various operation processes represent how the user operates various pieces of project software or communication software, performs an internet search, or fills out forms on the electronic device ED1. In the present embodiment, the automated operation processes AFL1 to AFLN are processes that simulate editing of a file by the user through the computer vision recognition.

In the present embodiment, corresponding ones of the automated operation processes can be pre-recorded in each of the blocks B1 to BN of the first file AT1. That is, the automated operation processes in each of the blocks B1 to BN can be edited and adjusted via the process automation application AMAPP1 or other relevant procedures. The file format of the first file AT1 and that of the specified request IC1 are openable by one of the multiple pieces of software installed in the electronic device ED1. The specified request IC1 can also be the image information photographed or recorded by the camera module (not shown in the figures) that is connected to the electronic device ED1.

### Beneficial Effects of the Embodiments

In conclusion, the automated file adjustment method and the automated file adjustment system provided by the present disclosure can assist the user in quickly and efficiently completing a complicated file adjustment task that takes up a great amount of time and efforts, so as to effectively reduce labor and time costs. Furthermore, implementation costs and development time for process automation can be significantly reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An automated file adjustment method, which is applicable to an electronic device, the automated file adjustment method comprising:
selecting, from a plurality of automated operation processes in a database of the electronic device, at least one of the plurality of automated operation processes according to a content of a specified request; wherein the at least one of the plurality of automated operation processes corresponds to the content of the specified request; and
adjusting, according to the at least one of the plurality of automated operation processes that corresponds to the content of the specified request, a content of a first file, so as to obtain a content of the adjusted first file.

2. The automated file adjustment method according to claim 1, further comprising:
comparing the content of the specified request with the content of the adjusted first file, so as to obtain a comparison result; and
determining, according to the comparison result, whether or not to output the content of the adjusted first file.

3. The automated file adjustment method according to claim 2, wherein the plurality of automated operation processes are determined according to a plurality of blocks that are established in the content of the first file by a user.

4. The automated file adjustment method according to claim 3, wherein the plurality of blocks in the content of the first file include a graphic, a text, a file format, an inspection process, or a line segment; wherein each of the plurality of automated operation processes at least corresponds to one of the plurality of blocks.

5. The automated file adjustment method according to claim 4, wherein, without altering a software implementation or an underlying code connection of the electronic device, the plurality of automated operation processes are performed by a plurality of peripheral devices, multiple pieces of software, multiple pieces of firmware, or multiple pieces of hardware installed in the electronic device.

6. An automated file adjustment system, comprising:
an electronic device, wherein the electronic device includes a process automation application;
wherein, from a plurality of automated operation processes in a database of the electronic device, the process automation application selects at least one of the plurality of automated operation processes according to a content of a specified request; wherein the at least one of the plurality of automated operation processes corresponds to the content of the specified request;
wherein, according to the at least one of the plurality of automated operation processes that corresponds to the content of the specified request, the process automation application adjusts a content of a first file to obtain a content of the adjusted first file;
wherein the process automation application compares the content of the specified request with the content of the adjusted first file to obtain a comparison result;
wherein, according to the comparison result, the process automation application determines whether or not to output the content of the adjusted first file.

7. The automated file adjustment system according to claim 6, wherein the plurality of automated operation processes are determined according to a plurality of blocks that are established in the content of the first file by a user.

8. The automated file adjustment system according to claim 7, wherein the plurality of blocks in the content of the first file include a graphic, a text, a file format, an inspection process, or a line segment; wherein the at least one of the plurality of automated operation processes at least corresponds to one of the plurality of blocks.

9. The automated file adjustment system according to claim 8, wherein, without altering a software implementation or an underlying code connection of the electronic device, the plurality of automated operation processes are performed by a plurality of peripheral devices, multiple pieces of software, multiple pieces of firmware, or multiple pieces of hardware installed in the electronic device.

10. The automated file adjustment system according to claim 9, wherein the at least one of the plurality of automated operation processes is to perform a mouse click operation process, a keyboard operation process, or a software-automated operation process of the electronic device through a computer vision recognition procedure; wherein the software-automated operation process is to execute one of the multiple pieces of software by a mouse or a keyboard, and the plurality of peripheral devices include the mouse or the keyboard.
